(19) United States
(12) Patent Application Publication
(10) Pub. No.: US 2026/0032392 A1
(43) Pub. Date: Jan. 29, 2026

(54) VOICE COIL AND SPEAKER MODULE

(71) Applicant: AAC Microtech (Changzhou) Co., Ltd., Changzhou City (CN)

(72) Inventor: Chao Zhang, Changzhou (CN)

(21) Appl. No.: 19/001,518

(22) Filed: Dec. 25, 2024

Related U.S. Application Data
(63) Continuation of application No. PCT/CN2024/106923, filed on Jul. 23, 2024.

(51) Int. Cl. H04R 9/04; H04R 9/02; H04R 9/06

(52) U.S. Cl. CPC H04R 9/046; H04R 9/025; H04R 9/06; H04R 2400/11

(57) ABSTRACT

The present invention provides a voice coil and a speaker module. The voice coil of the present invention includes a first winding switching portion located between winding layers with different numbers of windings, which is arranged in a transition area of the number of windings of the winding layers. According to the present invention, arranging the first winding switching portion in the transition area of the number of windings of the winding layers can absorb the thickness of the first winding switching portion via the accommodating space, so that the arrangement of the first winding switching portion does not increase the wall thickness of the voice coil, thereby reducing the influence of the voice coil on the magnetic gap and improving conversion efficiency. Applying the voice coil to the speaker module can also improve the sensitivity of the speaker module.

### TECHNICAL FIELD

The present invention relates to the technical field of electroacoustic, and more specifically to a voice coil and a speaker module.

### BACKGROUND

The voice coil of the speaker module in the prior art is composed of N winding layers 210 arranged from inside to outside. Since the N winding layers 210 are wound using a single enameled wire, a winding switching portion is formed when switching from the Nth layer to the (N+1)th layer during the winding process. As shown in FIG. 1, the winding switching portions of the voice coil in the prior art are collectively arranged on the corresponding areas from inside to outside, which causes the winding switching portions to overlap from inside to outside, resulting in an increase in wall thickness in the area of the voice coil corresponding to the winding switching portion. The thickened wall occupies more magnetic gap space and affects the magnetic gap, further reducing the sensitivity of the speaker module.

Therefore, there is a need to provide a voice coil that can reduce the impact on the magnetic gap and improve the sensitivity of the speaker module, as well as a speaker module having the voice coil.

### SUMMARY

An objective of the present invention is to provide a voice coil and a speaker module, to enhance the structural compactness of the voice coil, minimize the impact of the voice coil on the magnetic gap, and improve the sensitivity of the speaker module having the voice coil.

The technical solution of the present invention is as follows.

According to a first aspect of the present invention, a voice coil is provided, which includes N winding layers formed by winding from inside to outside, where N is an integer greater than 1, and adjacent winding layers are connected by a winding switching portion. A number of windings for each of the winding layers is not exactly the same, the winding switching portion comprises a first winding switching portion located between winding layers with different numbers of windings, and a second winding switching portion located between winding layers with the same numbers of windings; The first winding switching portion is arranged in a transition area of the number of windings of the winding layers. The first winding switching portion and the second winding switching portion are correspondingly arranged along a wall-thickness direction of the voice coil. The winding layers with the same number of windings are arranged in a staggered manner, and the first winding switching portion is arranged in a staggered gap formed by the staggered winding layers.

Optionally, the first winding switching portion and the second winding switching portion are scattered, and their projections along z-direction do not overlap with each other.

Optionally, the winding layers are connected from inside to outside to form a voice coil body, and the voice coil further includes a voice coil input terminal and a voice coil output terminal which are respectively connected to two ends of the voice coil body.

Optionally, the voice coil is made of an enameled wire, and a conductive core of the enameled wire is made of copper, aluminum, copper-aluminum alloy, or copper-clad aluminum.

According to a second aspect of the present invention, a speaker module is provided, which includes a cone bracket and a vibration system and a magnetic circuit system housed within the cone bracket. The vibration system includes the aforementioned voice coil.

Optionally, the magnetic circuit system includes an upper clamping plate and a lower clamping plate arranged in parallel; an inner magnet, a pole plate, and an outer magnet arranged on the lower clamping plate; and a peripheral magnet arranged along a circumferential direction of the inner magnet. A magnetic gap is formed between the inner magnet and the peripheral magnet, and the voice coil is arranged within the magnetic gap. The inner magnet, pole plate, and outer magnet are arranged on the lower clamping plate from bottom to top.

Optionally, the vibration system further includes an inner vibration diaphragm above the outer magnet, a frame arranged along the outer periphery of the inner vibration diaphragm, an upper vibration diaphragm arranged along the outer periphery of the frame, a flexible circuit board below the upper vibration diaphragm, and a lower vibration diaphragm below the flexible circuit board. The flexible circuit board is electrically connected to the voice coil, and the frame is attached to the flexible circuit board to support the vibration system on the flexible circuit board.

The present invention has the following beneficial effects. The winding switching portion of the voice coil according to the present invention includes a first winding switching portion and a second winding switching portion. The first winding switching portion is arranged in a transition area of the number of windings of the winding layers. The structure of the transition area of the number of windings of the winding layers forms a vacancy, which forms an accommodating space for the first winding switching portion. Arranging the first winding switching portion in the transition area of the number of windings of the winding layers can absorb the thickness of the first winding switching portion via the accommodating space, so that the arrangement of the first winding switching portion does not increase the wall thickness of the voice coil, thereby reducing the influence of the voice coil on the magnetic gap and improving conversion efficiency. Applying the voice coil to the speaker module can also improve the sensitivity of the speaker module.

### BRIEF DESCRIPTION OF THE DRAWINGS

FIG. 1 is a schematic diagram illustrating the distribution of winding switching portions in the winding layers of a voice coil in the prior art.

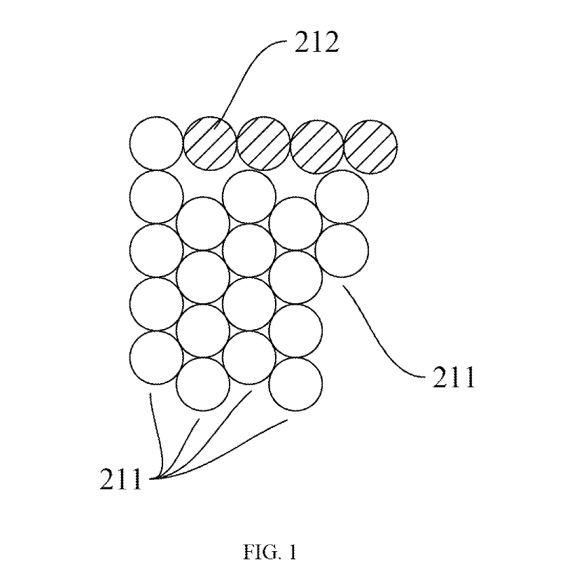

FIG. 2 is a structural schematic diagram of winding layers in a voice coil of the present invention.

FIG. 3 is another structural schematic diagram of winding layers in the voice coil of the present invention.

FIG. 4 is a structural schematic diagram of the voice coil of the present invention.

FIG. 5 is a structural schematic diagram of a speaker module of the present invention.

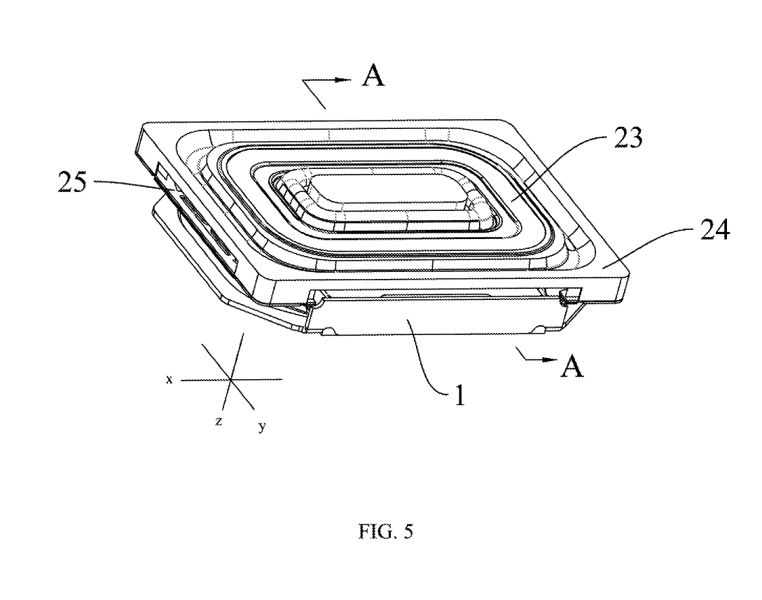

FIG. 6 is a schematic cross-sectional view of FIG. 5 taken along A-A direction.

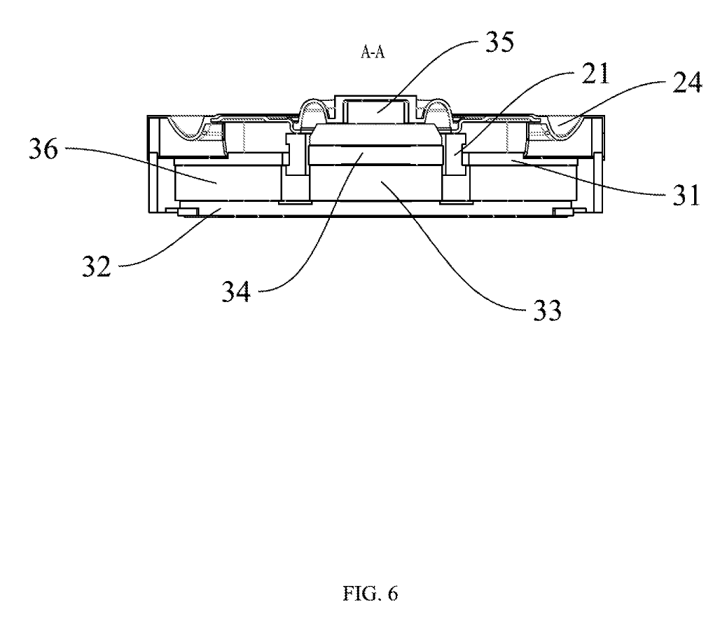

FIG. 7 is a schematic exploded view of the speaker module.

### DETAILED DESCRIPTION OF THE EMBODIMENTS

The present invention will be further described below in combination with the accompanying drawings and embodiments.

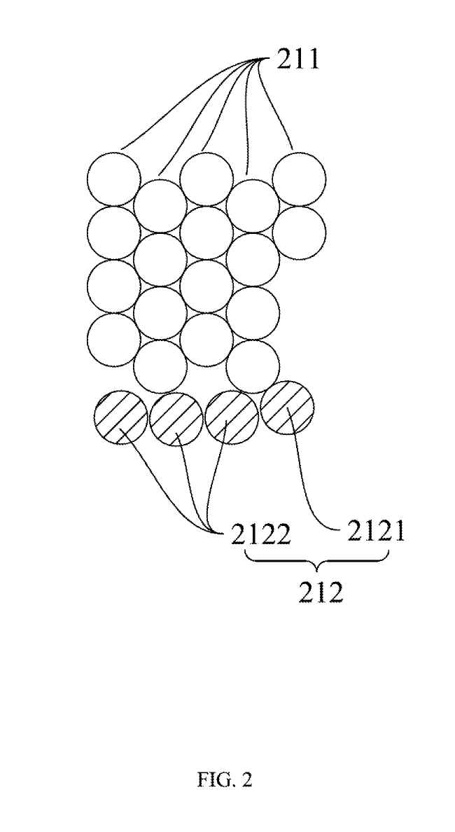

Embodiments: Referring to FIG. 2 to FIG. 4, in some embodiments, a voice coil 21 includes N winding layers 211 formed by winding from inside to outside, where N is an integer greater than 1, and adjacent winding layers 211 are connected by a winding switching portion 212. A number of windings for each of the winding layers 211 is not exactly the same. The winding switching portion 212 includes a first winding switching portion 2121 located between winding layers 211 with different numbers of windings, and a second winding switching portion 2122 located between winding layers 211 with the same numbers of windings. The first winding switching portion 2121 is arranged in a transition area of the number of windings of the winding layers 211.

The winding switching portion 212 of the voice coil 21 according to the present invention includes a first winding switching portion 2121 and a second winding switching portion 2122. The first winding switching portion 2121 is arranged in a transition area of the number of windings of the winding layers 211. The structure of the transition area of the number of windings of the winding layers 211 forms a vacancy, which forms an accommodating space for the first winding switching portion 2121. Arranging the first winding switching portion 2121 in the transition area of the number of windings of the winding layers 211 can absorb the thickness of the first winding switching portion 2121 via the accommodating space, so that the arrangement of the first winding switching portion 2121 does not increase the wall thickness of the voice coil 21, thereby reducing the influence of the voice coil 21 on the magnetic gap and improving conversion efficiency. After applying the voice coil 21 to the speaker module, the sensitivity of the speaker module can also be improved.

It should be noted that "inward direction" refers to the direction directing towards the central axis of the voice coil, while "outward direction" refers to the direction directing away from the central axis of the voice coil. The x-direction, y-direction, and z-direction are mutually perpendicular in space, with the z-direction being parallel to the vibration direction.

As shown in FIG. 2, in some embodiments, the first winding switching portion 2121 and the second winding switching portion 2122 are correspondingly arranged along a wall-thickness direction of the voice coil 21. The first winding switching portion 2121 is arranged in a transition area of the number of windings of the winding layers 211. The structure of the transition area of the number of windings of the winding layers 211 forms a vacancy, which forms an accommodating space for the first winding switching portion 2121. Arranging the first winding switching portion 2121 in the transition area of the number of windings of the winding layers 211 can absorb the thickness of the first winding switching portion 2121 via the accommodating space. Under this configuration, the wall thickness formed by the structural arrangement of the winding switching portion 212 is less than the maximum wall thickness of the voice coil 21, avoiding the impact on the magnetic gap caused by the increased wall thickness of the voice coil 21 resulted from the presence of the winding switching portion 212.

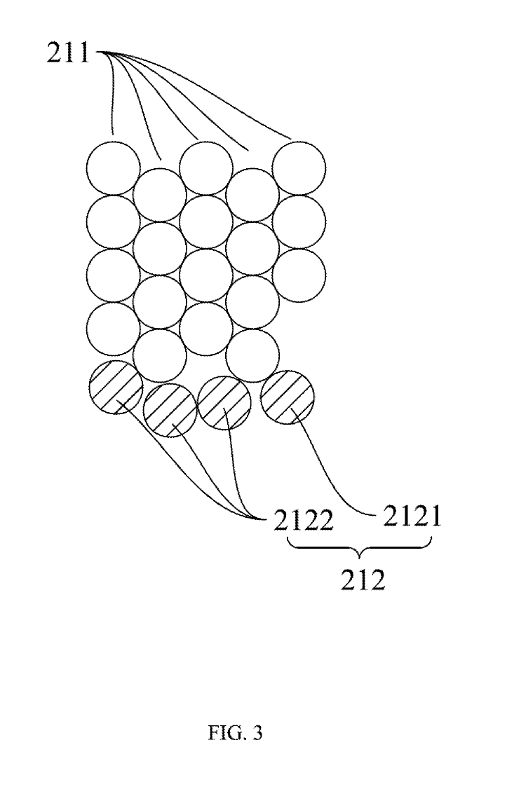

As shown in FIG. 3, in further embodiments, the winding layers 211 with the same number of windings are arranged in a staggered manner. When the winding layers 211 are arranged in a staggered manner, the enameled wire of the outer winding layer 211 is wound in the gap of the enameled wire of the inner winding layer 211. The first winding switching portion 2121 is arranged in a staggered gap formed by the staggered winding layers 211. In this embodiment, under the condition that the first winding switching portion 2121 is arranged in the transition area of the number of windings of the winding layers 211, the position of the second winding switching portion 2122 is further adjusted to be positioned within the staggered space of the winding layers 211, which further reduces the increase in wall thickness of the voice coil 21 caused by the presence of the winding switching portion 212, thereby avoiding the impact of the increased wall thickness of the voice coil 21 on the magnetic gap.

In some embodiments, the first winding switching portion 2121 and the second winding switching portion 2122 are scattered, and their projections along the z-direction do not overlap with each other. The scattered arrangement of the first winding switching portion 2121 and the second winding switching portion 2122 avoids the increase in the wall thickness of the voice coil 21 caused by the overall collective arrangement of the winding switching portion 212 along the wall thickness direction of the voice coil 21, further reducing the impact of the voice coil 21 on the magnetic gap, ensuring the conversion efficiency of the voice coil 21, and improving the sensitivity of the speaker module equipped with the voice coil 21.

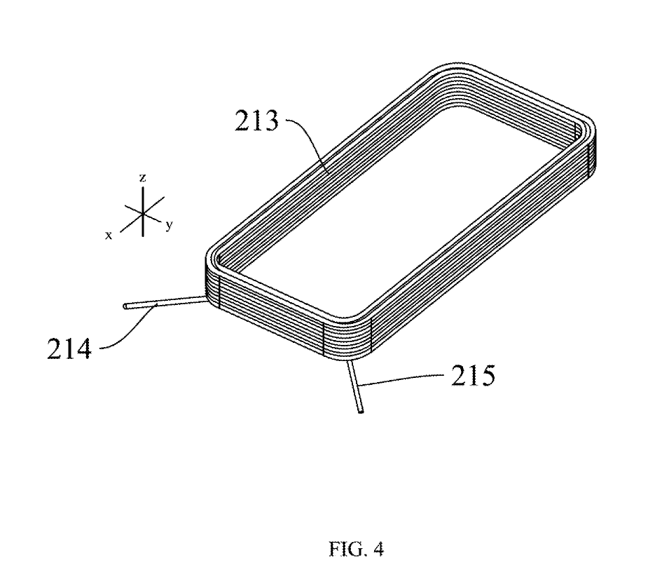

Optionally, referring to FIG. 4, the winding layers 211 are connected from inside to outside to form a voice coil body 213, and the voice coil 21 further includes a voice coil input terminal 214 and a voice coil output terminal 215 which are respectively connected to two ends of the voice coil body 213.

The voice coil 21 is made of an enameled wire, and a conductive core of the enameled wire is made of copper, aluminum, copper-aluminum alloy, or copper-clad aluminum.

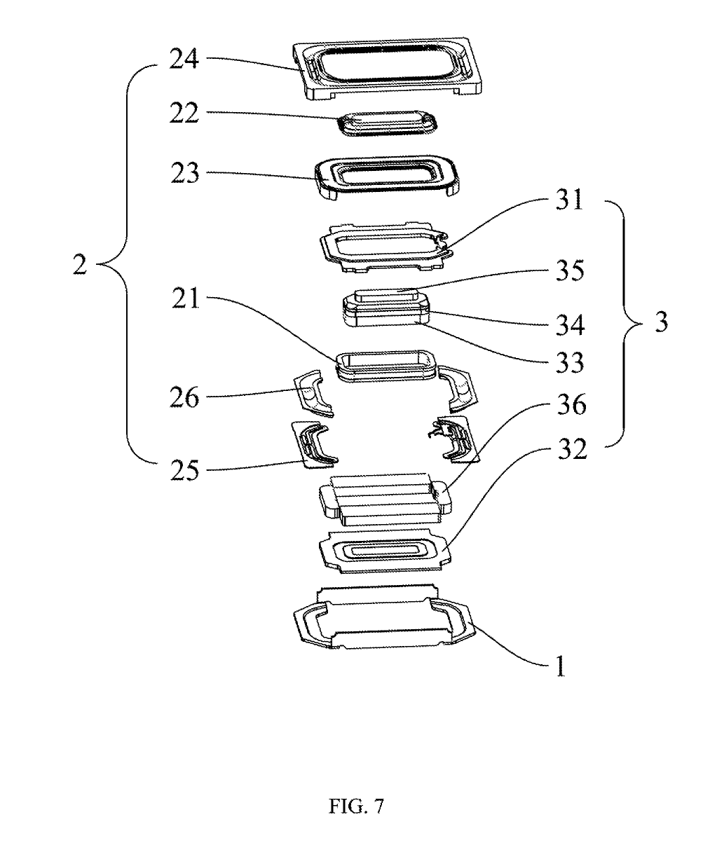

The embodiments of the present invention further provide a speaker module, as shown in FGI. 5 to FIG. 7. The speaker module includes a cone bracket 1 and a vibration system 2 and a magnetic circuit system 3 housed within the cone bracket 1. The vibration system 2 includes the aforementioned voice coil 21.

Further, the magnetic circuit system 3 includes an upper clamping plate 31 and a lower clamping plate 32 arranged in parallel; an inner magnet 33, a pole plate 34, and an outer magnet 35 arranged on the lower clamping plate 32; and a peripheral magnet 36 arranged along a circumferential direction of the inner magnet 33. A magnetic gap is formed between the inner magnet 33 and the peripheral magnet 36, and the voice coil 21 is arranged within the magnetic gap. The inner magnet 33, pole plate 34, and outer magnet 35 are arranged on the lower clamping plate 32 from bottom to top. It should be noted that the "upward direction" refers to the direction directing away from the lower clamping plate 32 along the z-axis, and the "downward direction" refers to the direction directing towards the lower clamping plate 32 along the z-axis.

The vibration system 2 further includes an inner vibration diaphragm 22 above the outer magnet 35, a frame 23 arranged along the outer periphery of the inner vibration diaphragm 22, an upper vibration diaphragm 24 arranged along the outer periphery of the frame 23, a flexible circuit board 25 below the upper vibration diaphragm 24, and a lower vibration diaphragm 26 below the flexible circuit board 25. The flexible circuit board 25 is electrically connected to the voice coil 21, the voice coil 21 is electrically connected to the flexible circuit board 25 respectively via the voice coil output terminal 215 and the voice coil input terminal 214, and the frame 23 is attached to the flexible circuit board 25 to support the vibration system 2 on the flexible circuit board 25.

The above description only shows embodiments of the present invention. It should be noted herein that for those skilled in the art, improvements may be made without departing from the inventive concept of the present invention, and those improvements still fall within the scope of protection of the present invention.

What is claimed is:

1. A voice coil, comprising:
N winding layers formed by winding from inside to outside,
wherein N is an integer greater than 1, and adjacent winding layers are connected by a winding switching portion;
a number of windings for each of the winding layers is not exactly the same, the winding switching portion comprises a first winding switching portion located between winding layers with different numbers of windings, and a second winding switching portion located between winding layers with the same numbers of windings;
the first winding switching portion is arranged in a transition area of the number of windings of the winding layers, and the first winding switching portion and the second winding switching portion are correspondingly arranged along a wall-thickness direction of the voice coil; and
the winding layers with the same number of windings are arranged in a staggered manner, and the first winding switching portion is arranged in a staggered gap formed by the staggered winding layers.

2. The voice coil according to claim 1, wherein the first winding switching portion and the second winding switching portion are scattered, and projections thereof along z-direction do not overlap with each other.

3. The voice coil according to claim 1, wherein the winding layers are connected from inside to outside to form a voice coil body, and the voice coil further comprises a voice coil input terminal and a voice coil output terminal which are respectively connected to two ends of the voice coil body.

4. The voice coil according to claim 1, wherein the voice coil is made of an enameled wire, and a conductive core of the enameled wire is made of copper, aluminum, copper-aluminum alloy, or copper-clad aluminum.

5. A speaker module, comprising: a cone bracket, and a vibration system and a magnetic circuit system housed within the cone bracket, wherein the vibration system comprises the voice coil according to claim 1.

6. The speaker module according to claim 5, wherein
the magnetic circuit system comprises:
an upper clamping plate and a lower clamping plate arranged in parallel;
an inner magnet, a pole plate, and an outer magnet arranged on the lower clamping plate; and
a peripheral magnet arranged along a circumferential direction of the inner magnet;
wherein a magnetic gap is formed between the inner magnet and the peripheral magnet, the voice coil is arranged within the magnetic gap, and
the inner magnet, pole plate, and outer magnet are arranged on the lower clamping plate from bottom to top.

7. The speaker module according to claim 6, wherein
the vibration system further comprises:
an inner vibration diaphragm above the outer magnet,
a frame arranged along an outer periphery of the inner vibration diaphragm,
an upper vibration diaphragm arranged along an outer periphery of the frame,
a flexible circuit board below the upper vibration diaphragm, and
a lower vibration diaphragm below the flexible circuit board,
wherein the flexible circuit board is electrically connected to the voice coil, and the frame is attached to the flexible circuit board to support the vibration system on the flexible circuit board.
